(19) United States
(12) Patent Application Publication
(10) Pub. No.: US 2009/0324913 A1
(43) Pub. Date: Dec. 31, 2009

(54) SHEET AND PRODUCT BASED ON FOAMED SHAPED STARCH

(75) Inventors: Angelo BASTIOLI, Foligno (IT); Catia BASTIOLI, Novara (IT); Roberto LOMBI, Novara (IT); Piero SALVATI, Terni (IT)

Correspondence Address: WESTERMAN, HATTORI, DANIELS & ADRIAN, LLP, 1250 CONNECTICUT AVENUE, NW, SUITE 700, WASHINGTON, DC, 20036, US

(73) Assignee: NOVAMONT S. P. A., Novara (IT)

(21) Appl. No.: 12/485,495

(22) Filed: Jun. 16, 2009

Related U.S. Application Data
(63) Continuation of application No. 09/784,707, filed on Feb. 15, 2001, now abandoned.

(30) Foreign Application Priority Data
Feb. 15, 2000 (IT) TO2000A000141

(51) Int. Cl. B32B 5/18; B32B 3/26

(52) U.S. Cl. 428/219; 428/304.4; 442/221; 442/370

(57) ABSTRACT

Materials in the form of foam sheet comprising destructured or complexed starch expanded as a contiguous phase, having a density lying between 20 and 150 kg/m³, cell dimensions in the range lying between 25 and 700 μm and with a cell distribution such that 80% of them have a dimension lying between 20 and 400 μm in the absence of stretching.

This is a continuation of application Ser. No. 09/784,707, filed Feb. 15, 2001

### BACKGROUND OF THE INVENTION

The present invention relates to partly-finished products such an sheets of different thicknesses and profile based on destructured and/or complexed starch, expanded by means of an extrusion process, which can be used as such, variously treated, as biodegradable products and which can be formed at the output of the extrusion head or in a subsequent stage, and to products formed there from.

Starch-based products according to the invention are particularly suitable for use in the packaging sector.

The use of plastics materials such as polystyrene, polyurethane, polyethylene and polypropylene has until now dominated in the packaging sector; however, the problems of disposal associated with these products is opening new prospects for starch-based material in that they are biodegradable and from renewable sources, in particular in the foam materials sector.

The state of the art shows various approaches to the formation of foamed starch-based products. However, because of the nature and characteristics of starch it appears at present problematical to succeed in obtaining starch-based foamed products with optimum properties in terms of dimensions and cell distribution, and density of the partly-finished product such as to permit the conversion of the partly-finished product in a regular manner at an industrial rate into a competitive product as far as weight and performance is concerned, in particular as far as the aspect of fragility of the product at hinge points is concerned. This is particularly true for the preparation of starch-based foams utilised for the formation of sheets and associated moulded items.

In particular, no starch-based partly-finished product is yet available on the market with starch in continuous phase, which is able to be shaped using an industrial process, with optimum properties in terms of dimensions, cell distribution and density such as to render the resultant product resilient, in particular in the hinge regions even after successive bending.

In affect, whilst ouch attention has until now been directed to research and making available various starch-based compositions comprising combinations with various synthetic polymers and additives, the problem of making available extrusion and foaming processes which make it possible to arrive at the production of foamed product a having well determined properties such as homogeneity of the foamed structure, surface smoothness, and low fragility of the foamed workplaces has received limited attention.

### BRIEF DESCRIPTION OF THE DRAWINGS

FIG. 1 illustrates a clam shell according to the present invention.

FIG. 2 illustrates a die for forming the clam shell of FIG. 1

### STARTING COMPOSITION

The products according to the invention are obtained from starting compositions supplied to the extruder containing starchy material, water in percentages lying between 4 and 30 percent wt. of the total composition, possibly a thermoplastic polymer and possibly further additives such as plasticizers, lubricants, surfactants, weak acids etc. As far as the components of the starting composition are concerned, the contents of the European Patent Application EP/0 696 611 are incorporated into the present application by reference.

In particular, the present invention relates to foamed, partly-finished products such as sheets of various thickness and profile which can be used themselves as products, and associated shaped on formed products comprising destructured and/or complexed starch as continuous phase in the partly-finished product and the finished product itself.

As far as the starch material is concerned, this can be both crude and modified starch or a mixture of these. The use of potato, wheat, maize and tapioca starch is preferred. As far as modified starches are concerned, these can be physically and chemically modified, for example ethoxylated starches, acetate starches, butyrate starches, propionate starches, hydroxypropylated starches, cationic starches, oxidated starches, cross-linked starches, gelatinised starches, starches complexed with molecules and/or polymers able to give “V” type complexes, dextrinated starches and starches grafted with chains such as polyesters, polyurethanes, polyesters-urethanes, polyureas, polyesters-ureas, polysiloxanes, silanes, titanatas, fat chains and so on. The preferred chemically or physically modified starches are those with any kind of modification, which have an intrinsic viscosity, measured in DMSO at 30° C., lying between 2 dl/g and 0.6 dl/g, preferably between 1.5 dl/g and 0.8 dl/g, and more preferably between 1.3 dl/g and 1 dl/g.

It is intended that flours and meals resulting from the discharge from mill workings lie within the invention.

The term destructured starch is intended to mean a starch which has been treated thermally above the glass transition temperature and fusion temperature of its components to obtain the consequent disordering of the molecular structure of the starch grains and to render it thermoplastic. Reference is made in this respect to patents EP 118240 and EP 327505.

Complexed starches on the other hand mean a starch where the amylose component is partially or entirely engaged in the formation of “V” type complexes (single helix structures) which have second derivative X-ray spectral and FTIR characteristics.

With reference to the thermoplastic polymer, polymers having a melting point or glass transition point lying between 60 and 175° C. are particularly relevant for the products according to the present invention, and in particular those having such points lying between 70 and 110° C.

In particular usable polymers are selected from:
polymers of natural origin, which can be both modified and non-modified, in particular those derived from cellulose such as cellulose acetate, cellulose propionate, cellulose butyrate and their co-polymers, with a degree of substitution lying between 1 and 2.5; polymers of the alkyl cellulose type, hydroxyalkyl cellulose, carboxyalkyl cellulose, in particular carboxymethyl cellulose, nitrocellulose and chitosane, pullulan or casein and caseinate, rein, soya protein, alginic acid and alginates, natural rubbers, polyaspartates, gluten;
biodegradable polymers of synthetic or fermentative origin, in particular polyesters, such as polymers or co-polymers, of C₂-C₂₄ aliphatic hydroxyacids, or their corresponding lactones or lactides, in particular polymers of lactic acid having various D/L lactic acid ratios, and preferably with a D-lactic content comprised between 4-25% mole, co-polymers of polylactic acid with aliphatic polyesters and aromatic-aliphatic polyesters, polycaprolactone, polyvalerolactone, their co-polymers and polyesters derived from difunctional acids and aliphatic diols, aliphatic-aromatic polyesters, in particular co-polymers of the alkylene-terephthalate adipate type whether treated or not with chain extenders, preferably with quantities of terephthalic acid less than 40 mole percent, preferably lass than 30% mole, epoxy resins in general and bisphenolic resins in particular;
polymers able to interact the starch to form complexes, that is to say polymers which contain hydrophilic groups intercalated with hydrophobic sequences, for example, ethylenevinyl alcohol co-polymers, ethylenevinyl acetate co-polymers, acrylic esters, ethylene acrylic ester co-polymers, co-polymers of ethylene with unsaturated acids such as acrylic acid, methacrylic acid, crotonic acid, itaconic acid; co-polymers having alcoholic and carboxylic functional groups aliphatic polyesters and/or aliphatic-aromatic polyesters, epoxy resins including those containing bisphenol resins;
polymers forming hydrogen bonds with starch, in particular, polyvinyl alcohols of varying degrees of hydrolysis, possibly modified as acrylates or methacrylates and polyvinyl alcohols preliminarily plasticised or modified for the purpose of lowering the melting point.

Preferred thermoplastic polymers are the polyvinyl, alcohols, co-polymers of an olefinic monomer, preferably ethylene, with a monomer chosen from vinyl alcohol, vinyl acetate, acrylic acid and methacrylic acid, aliphatic polyesters derived from caprolactone, polyalkylenesuccinates, polymers of azelaic acid, sebacic acid, brassilic acid and their co-polymers, aliphatic polyamides, polyalkylenesebacates, polyalkylene-azelates, polyalkylenebrassilates, in particular with diols comprised between C₂-C₁₃, polyesters containing dimeric acids, aromatic-aliphatic polymers of the polyalkylene terephthalate adipate type and the epoxy resins, particularly with bisphenolic groups.

The extruded foamed partly-finished product according to the invention further preferably contains a nucleating agent. The use of a suitable nucleating agent in fact makes it possible to increase the homogeneity of the cells of the sheet. The quantity of nucleating agent utilised in the course of the process depends on the process conditions and the desired morphology for the extruded, partly-finished product. Preferably, the quantity of nucleating agent with respect to the starting composition lies in the range between 0.05 and 10% by weight, preferably between 0.5 and 7% and more preferably between 1 and 5%.

Usable nucleating agents are, for example, inorganic compounds such as talc (magnesium silicate), calcium carbonate, sulphates such as sodium and barium, titanium dioxide etc, possibly surface treated with adhesion promotors such as silanes, titanates, etc. Organic fillers and fibres such as wood powder, cellulose powder, grape residue, bran, maize husks, other natural fibres in concentrations between 0.5 and 20% may also be utilised. Further, substances able to be dispersed and/or to be reduced in lamellae with submicronic dimensions, preferably less than 500 μm, more preferably less than 300 μm, and even more preferably less than 50 μm may be utilised in order to improve stiffness, water and gas permeability, dimensional stability. Particularly preferred are zeolites and silicates of various kind such as wollastanites, montmorillonites, hydrotalcytes functionalised with molecules able to interact with starch. Particularly preferred are submicronic particles of complexed starch also with specific functional groups introduced by virtue of silanes, titanates and other.

The starting compositions can moreover contain suitable additives such as lubricating agents and/or dispersants, flame retardants, colorants, plasticising agents, fillers etc. In particular, food oils such as palm, maize, soya, sunflower oil are particularly good, as are fatty acids from C₁₂ to C₂₂ and their glycerides with various degrees of substitution and in particular synthetic hydrogenated fats or fats of animal origin which are solid at least at ambient temperatures and, preferably, above ambient temperature to improve the moisture resistance and reduce wet ability. It is also possible to use weak acids such as lactic, tartaric, citric acid etc to regulate the viscosity of the starch during the extrusion, and plasticizers such as glycerine, sorbitol, mannitol, pentaerithritol, and derivatives thereof, esters of citric acid and their derivatives.

The starting composition can be supplied directly to the extruder or can be supplied in the form of preliminarily extruded or pelletised granules.

### Process for the Production of the Sheet

The foamed, partly-finished product according to the invention is prepared by means of a process of extrusion of the basic starch composition effected by means of particular extruders such as slow twin screw extruders or two single screw tandem extruders in cascade or their combination, in such a way as to guarantee significantly long dwell times for the purpose of optimising the viscosity of the starchy material and the homogenisation of the nucleating agents and mixing of the foaming agents in the molten mass. In particular the use of a slow twin screw extruder is preferred.

In the performance of the extrusion process the extrusion temperature can vary as a function of the particular formulation and the desired properties of the partly-finished product and the finished product. The temperature control of the molten mass is therefore significant for obtaining products with specific characteristics.

The temperature of the molten mass in the course of the extrusion process can generally very along the profile of the screw from 50 to 230° C., preferably between 60 and 210° C. and more preferably between 70 and 200° C.

The foaming of the thermoplastic products according to the invention is achieved by the use of a suitable mixture of physical foaming agents which can also contain chemical foaming agents, in particular the use of CO₂ in gaseous form is preferred, in combination with water or CO₂ in gaseous form in combination with water end other physical and chemical foaming agents. Among the chemical foaming agents can be taken into consideration, among others, citric acid, bicarbonate and their combinations.

The foaming agent is preferably supplied to a region of the extruder in which the starting composition supplied to the extruder is present in the molten state. In particular the foaming agent is supplied to an advanced region of the extruder in such a way that the extrusion process is not altered by the phenomenon of regurgitation of the molten mass towards the extruder feed zone.

The CO₂ is supplied in concentrations greater than 0.4%, preferably greater than 0.8%, with respect to the total composition fed to the hopper, to a region where the melt is at a temperature lying between 100° C. and 200° C., preferably between 130° C. and 190° C. The mixture of CO₂ and H₂O and the specific concentrations are determining factors for the low density and the cell structure.

The quantity of CO₂ can vary in a range lying between 0.4% and 10% by weight, preferably between 0.8% and 7% and more preferably between 1% and 4% by weight. The CO₂ is added to the melt. The total water content of the composition fed to the hopper of the extruder for the expansion is lying between 4% and 30% by weight, preferably between 8% and 20% and more preferably between 10% and 18% by weight.

The extruder can be completed by extruder heads of the flat or tubular type; tubular heads are particularly preferred.

Preferably the configuration of the head of the extruder is such as to guarantee a homogeneous supply to the nozzle. With the starting compositions of the foam sheet according to the invention this problem is relevant since small variations of shear rata can generate significant variations in the local viscosity, with consequent alterations in the foaming process and therefore manifest irregularities in the sheet in terms of thickness thereof, cell dimensions, presence of preferential flow etc.

The head of the extruder is therefore preferably configured in such a way as to cancel the elastic memory of the material and, at the same time, not create any foam before the entry of the material into the nozzle. The preferred extrusion shear rate ranges for the sheet are between 500 and 50,000 sec⁻¹, preferably between 800 and 40,000 sec⁻¹, and more preferably between 900 and 35,000 sec⁻¹.

At the output from the extrusion head, and before the forming process, the foamed sheet according to the invention can be laminated with layers of non-woven fabric, textile, paper, biodegradable and non-biodegradable films, or aluminium. As far as the non-woven or textile fabrics are concerned these can be made of natural fibres, such as, for example, fibres of jute, cotton, wool, fibres based on polysaccharides such as, for example, cellulose acetate, starch acetate, viscose etc, or fibres produced from biodegradable polymers and in particular aliphatic polyesters such as polylactic acid, polycaprolactone, polyalkylene carboxylate with dialcohols and diacids selected from the linear range C₂-C₁₃ and/or cycloaliphatic, aliphatic-aromatic polyesters, in particular of the family of terephthalate polyalkylene adipates and their co-polymers, particularly with a terephthalic acid content leas than 55% with respect to the amount of terephtalic acid+adipic acid, polyamides in particular based on caprolactam, aliphatic amines etc, aliphatic polyurethanes, polyester-urethanes, polyurea, and epoxy resins. The above biodegradable polymers can be utilised also in the form of films for lamination or coating.

The films are generally coupled to the sheet through temperature and/or the application of suitable biodegradable adhesives based on polymers, lactic acid, polyurethanes, polyvinyl acetates and polyvinyl alcohol, proteins such as casein and glutens, starches and other polysaccharides, hot melts particularly based on aliphatic polyesters.

The films can be obtained by casting or bubble film-forming and can be co-extruded with an adhesive surface for the foam support. Films, with a melting point greater than 60° C., preferably greater than 80° C., and more preferably greater than 100° C., are preferred.

The partly-finished product coupled to film can be used unformed, as the sheet as such, or in a foaming or shaping process to form finished products.

For the coating it is possible to utilise emulsions, solutions or dispersions of the type described in European patent EP 696612 for the treatment of expanded particles, considered included within the present invention. Natural and synthetic waxes can also be utilised, with melting points up to 120° C. depending on the application. In this case the treatment can be before or after the forming or shaping stage.

The foam sheet may also be co-extruded with expended layers of other starch based materials so to have differentiated properties between the inside and the outside of a multiplayer or it may be co-extruded with layers of materials having lower hydrophilicity such as the polyesters above mentioned for the laminated films.

The foam sheet according to the invention must be obtained starting from a homogeneous molten mass in which the nucleating agents and the gas and/or vapours are homogeneously dispersed throughout the molten mass. For this the dwell times in the extruder must lie between 5 and 40 minutes, preferably between 10 and 35 minutes, and more preferably between 15 and 25 minutes.

The foam sheet can be controlled in thickness by the extrusion conditions and calendering.

In the case of tubular sheet the head can be provided with air or steam blowing systems from within, as in the case of bubble film-forming, or orientation by air or steam blowing to distend the sheet and give it a biaxial stretch, avoiding or regulating the formation of waves. The sheet can have a thickness lying between 0.5 mm and 15 mm, preferably between 1.0 mm and 10 mm. The thickness of the partly finished product can be achieved by stretching and calendering the sheet.

The foam sheet may be corrugated and the corrugations may be exploited in order to increase the cushion properties of the foam. The corrugations may have different width and height. The height, which corresponds to the thickness of the resulting panel, may be about the double of the foam sheet thickness. The frequency of the corrugations may reach 350 per linear metre.

Sheets of this type can be combined together in multi layers, forming different geometries for different products in the packaging sector such as sheets and expanded blocks of high resilience, corners or protection containers. Specific examples of the sectors suitable for application are those of electrical domestic equipment, electronic products, the food sector, pharmaceuticals, design and furniture, mail order, and envelopes for couriers. The sheets can be utilised also in combination with other supports to form multi layers mixed with wood, paper, cardboard, textiles of natural and synthetic fibres, aluminium and other metals. In particular, the products of this type can be directly anchored to the piece to be packaged, exploiting their characteristic adhesiveness upon moistening or, preferably, with hot melts or melts to be sprayed.

Products obtained from coupling sheets or formed products can be protected by an external film to increase performance.

Products can also be rolls and tubes obtained by winding and gluing sheets, or by directly extruding tubes. Rolls and tubes can be utilised as supports for toilet paper, kitchen paper or other types or may be used as protection for cylindrical things such as bottles and others.

### Process for Forming the Sheet

Forming can be achieved by a continuous process or by a batch process.

The production of expanded products according to the invention by means of continuous processes provides for the extrusion/calendering phase, a possible conditioning phase and the forming phase to be consecutive. The production of foamed products according to the invention by means of batch processes provides for the extrusion/calendering phase with winding of the sheet into coils or collection in sheets; the partly-finished products can them be conditioned and formed in a second phase.

In a continuous foaming process it is envisaged that the partly-finished product in the form of sheet from the extruder would be maintained at a temperature not less than 40° C., and preferably not lass than 80° C. and having a water content lying between 6 and 30% by weight, preferably between 10 and 25% by weight and more preferably between 15 and 20% by weight. The temperature of the sheet must not exceed 150° C. and preferably 100° C.

In particular, if synthetic components are present, the forming temperature must be close to the glass transition temperature or the melting point of the thermoplastic polymer.

It is also possible to form the partly-finished product by a batch process by subjecting it to a preliminary conditioning process for the water content and temperature range referred to above for continuous processes.

The conditioning stage can immediately precede or be coincident with the forming station.

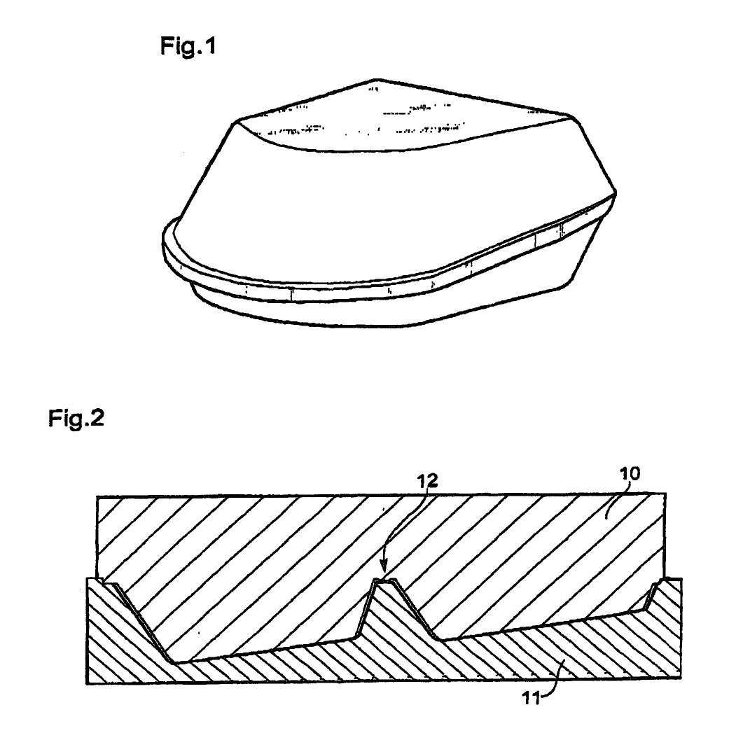

Products even of complex form, provided with particular, even aesthetic, characteristics such as, for example, the clam shell illustrated in FIG. 1, can be obtained with a forming process at ambient temperature, and in any event at temperatures not greater than 100° C., between abutting male and female mould to define the maximum level of compression and the final minimum thickness of the product.

A die for the forming of the clam shell of FIG. 1 with the foam sheet according to the present invention is illustrated, as a way of example, in FIG. 2. Male (10) and female (11) may be designed in such a way that they do not get in touch just next to the lateral walls of the clam shell, such roam between male and female allows the slipping of the foam sheet without tears during the forming.

The process forming the subject of the invention, together with, the characteristics of the partly-finished product generally allow forming cycles less than 20 seconds, preferably less than 10 seconds and more preferably less than 7 seconds. With reference to the forming process, the parameters relating to the water content and temperature are critical for the achievement of a good formability of the partly-finished product. The loss of water vapour from the partly-finished product at the outlet from the extruder nozzle in fact makes it necessary to exercise a strict control on the level of removal of water for the purpose of avoiding both phenomena of collapse and phenomena of excessive drying.

Forming can take place in moulds or dies at ambient temperature on-expanded but unopened tubular sheets. This system makes it possible simultaneously to mould two layers of sheet per mould, limiting the problems of drying of the sheets. If the tubular sheets are conveniently offset from one another it is possible to obtain a surface of the product having an aspect similar to the surface weave of a fabric.

Forming is normally conducted on an opened tube. In this case the water content is regulated by utilising a conditioning station which uses steam.

### Characteristics of the Sheet

The material which constitutes the partly-finished product or foamed sheet forming the subject of the present invention has an intrinsic viscosity in DMSO at 30° C. lying between 1.5 and 0.3 dl/g, preferably lying between 1.2 and 0.4 dl/g and more preferably between 1 and 0.6 dl/g.

In expanded partly-finished products according to the invention the cell dimension can vary in a range lying between 25 and 700 μm and preferably between 40 and 600 μm (as determined by microscopic inspection).

The expanded partly-finished product has closed cell morphology in which the cells are substantially non communicating with one another, which is different from the open cell morphology in which the cells are largely interconnected with one another.

The partly-finished product can have a density lying between 20 and 150 kg/m³, preferably lying between 25 and 100 kg/m³, more preferably between 30 and 70 kg/m³.

The foam structure of the sheet is characterised by a cell distribution in which 80% of the cells present, in the absence of stretching, have a dimension lying between 20 and 400 μm, preferably between 25 and 300 μm and more preferably between 30 and 200 μm.

When a stretch is applied to the sheet the cells can, however, be subjected to an orientation with thinning of the wall.

Also within the scope of the present invention is a sheet with optimised resilience properties, a density characteristic lying between 30 and 70 kg/m³, and with an average cell dimension between 80 and 120 μm.

Products forming the subject of the present invention are principally used in the food packaging sector and in particular as trays for food with a lifetime of the order of 30 days, for the packaging of meat, milk products, vegetables, eggs and fruit; holders for packages of glass, plastics or metal of very small dimensions, containers for fast food such as containers for hamburgers, potato chips and similar products; multi compartment containers for foods, known also as lunch boxes, cups for coffee and other hot or cold drinks for fast food and meals.

The formed products of the present invention are also used as containers for objects of small weight such as multi-compartment trays for portable telephones and small electrical domestic appliances in particular, with mechanical properties such as to avoid phenomena of abrasion encountered with containers of pressed paper etc.

In the case of food applications where liquids at high or low temperatures are to be expected, the containers can be co-extruded or coupled to another layer of foam or polyester film and/or cellulose acetate and/or starch or other polymer resistant to liquids at the temperature which will be experienced in use. In particular films of aromatic-aliphatic polyester type can be utilised and, specifically, polyalkylene terephthalate adipates, alkylene butyrates, polyalkylene succinates, polyalkylene sebacates, polyalkylene azelates, polycyclic alkylene dicarboxylates, in particular polyhexyldimethyldicarboxylates, olycyclohexyldicarboxylates. If it is necessary to absorb liquids as in the case of packaging for meat it is possible to consider the use of superabsorbent material which can inserted directly into the sheet, applied to the surface or in intermediate layers between two shells welded together or under the film which makes the tray impermeable.

Also to be considered the subject of the present invention are products formed for ovens and microwaves, possibly characterised by treatments with water-repellent coatings to avoid drying of the container during the cooking phase.

### Characteristics of the Formed Products

Formed products according to the invention have a closed cell structure with a relatively low density lying between 40 and 400 kg/m³, preferably between 45 and 200 kg/m³ and more preferably between 50 and 150 kg/m³.

Products formed according to the invention further have good properties of flexibility, in particular in the hinge region, thanks to the fine and homogeneous morphology of the cells. Such products also have a very good uniform surface.

Hinges, such as for examples the one numbered as 12 in FIG. 2, can be produced in products obtained in the forming phase, by forming ribs of the type used for cardboard hinges, are resistant to at least ten (preferably >20) consecutive opening at 180°/closing cycles at 35% RH and 23° C. without breakage, using about 2-4 seconds for each opening at 180°/closing operation, and preferably at least 100 consecutive opening and closing cycles at 40% RH and 23° C. without breaking, using about 2-4 seconds for each opening/closing cycles.

The good properties of flexibility can be tested also with a dynamometer with a climatic cell adapted to adjust the temperature and relative humidity at the above values. Samples of 25×10 cm with an hinge at the middle of their length can be submitted to opening/closing cycles from 0 to 180° with a velocity of in the range of 3000-10,000 mm/min of the mobile bar of the dynamometer.

### EXAMPLES

The invention is further illustrated by means of the following examples provided by way of illustrative and non-limitative example of the invention itself.

### Example 1

A mixture was prepared having the following composition:
88.9% of destructured potato starch with an intrinsic viscosity in DMSO at 30° C. of 1.1 dl/g and the water content of 14%.
8.9% by weight of polyvinylalcohol
1.8% by weight of talc
0.35% by weight of glycerol
0.36% by weight of loxial G10
2% by weight of water.

The composition was supplied to a slow twin screw extruder with co-rotating screws having a diameter (d)=113.8 mm and L/D ratio=19:1. At the end of the extruder was mounted an extrusion head for a tubular sheet with a diameter of 100 mm and lip opening of 0.5 mm. The dwell time of the melt in the extruder was about 20 minutes.

In addition to the water contained in the feed mixture, a further 1% by weight of CO₂ was also added to the molten mass as a further expansion agent, at a feed pressure equal to 37 bar. The CO₂ was introduced at the level of the eleventh diameter of the screw.

The operating conditions were as follows:

| | |
|---|---|
| RPM: | 16 |
| Temperature profile (° C.): | 95/120/120/150/180/180/185/190/197 |
| Feed rate: | 54 kg/h |
| Lip shear rate: | 912 sec⁻¹ |

The foamed sheet obtained had a density of 56 kg/m³ and a cell dimension lying between 40 and 170 μm, the average value of the cell dimension was 81 μm.

The intrinsic viscosity of the material constituting the sheet, taken in DMSO at 30° C., is 0.68 dl/g. The sheet was wound in a coil.

### Example 2

A mixture was prepared having the following composition:

| wheat starch | 34.4% (12% H₂0) |
|---|---|
| potato starch | 34.4% (16% H₂0) |
| polyvinylalcohol | 13.5% |
| H₂0 | 17.4% |
| Monoglyceride oleic acid | 0.3% |

This mixture was supplied to a twin screw APV 2080 extruder having a diameter (d)=80 mm and L/D ratio=40. It was operated in the following conditions:

| | |
|---|---|
| RPM: | 285 |
| Temperature profile: | 50/75/75/180/180/170/170/175/ |
| | 175/165/165/155/155/145/120 |

Degassing was regulated in such a way as to maintain in the granules a total water content of about 14.5%. The intrinsic viscosity of the pellets was 1.98 dl/g.

The granules thus obtained were mixed with 2.5% of talc having an average particle diameter of about 1.5 μm and supplied to a slow twin screw extruder with co-rotating screws having a diameter (d)=113.8 mm and L/D ratio=19:1 with an extrusion head for tubular sheet of 100 mm in diameter and 0.4 mm of lip separation, operating in the following conditions;

| | |
|---|---|
| RPM: | 14 |
| Temperature profile (° C.): | 90/120/120/140/165/165/170/186/186 |
| Feed rate: | 50 kg/h |
| Shear rate: | 1360 sec⁻¹ |

To the molten mass was added, as a further expanding agent, CO₂ in quantities equal to 1.5% by weight at a feed pressure equal to 40 bar.

The tubular sheet obtained had a thickness equal to about 3 mm a density of 70 kg per m³ and an average cell dimension equal to 90 μm (minimum/maximum cell dimension=10/290 μm). The water content of the sheet was equal to about 1.8% by weight and the intrinsic viscosity of the material constituting the sheet was m=1.1 dl/g.

### Example 3

The tubular sheet obtained by the example 2 was opened by subjecting it to a calendering and steam conditioning process until it had a water content in the sheet equal to 15%. The forming was achieved by means of a suitable mould, such that illustrated in FIG. 2, of the male-female type for hinged trays of the clam shell type suitable for fast food products.

Forming was conducted with dies at ambient temperature on the sheet maintained at a temperature about 80° C. by applying a pressure of 6 kg/cm². The moulding cycle was about 6 seconds and the product thus obtained bad a thickness equal to about 1.6 mm and a density in the bottom wall of 165 kg/m³.

In particular, the product obtained was constituted by two asymmetrical valves having a length of 12.5 cm connected by a hinge 10 cm wide. This hinge zone had particular properties of mechanical strength. After 20 successive headings for a time of 3 seconds (corresponding to about 5000 mm/min) for opening/closure cycles at 35% RH and 23° C. it continued to perform its function.

The product obtained also had a very smooth surface constituted by super-imposed flattened ribs which confer on the product a pleasing aesthetic aspect.

### Example 4

The coiled sheet obtained according to example 1 was maintained at a water content of 14%. To the sheet was applied a film of 14 μm of polybutyleneterephthalate-adipate containing 33% by mole of teraphthalate with an intrinsic viscosity in THF of 1.1 dl/g. The sheet with the applied film was brought to 80° C. and formed in the mould described in example 3. The container obtained was resistant to water at 80° C. for an hour, the time necessary for the temperature to fall from 80° C. to 20° C. without any collapse or soaking of the foamed starch container.

### Example 5

As for example 4, with the single difference of having applied a film of polyethylene sebacate. The tray was perfectly resistant to water without becoming saturated and/or collapse of the starchy product.

### Example 6

As for example 4, with the exception of the application of a non-woven fabric of viscose of 30 g/m², in place of the polyester film.

### Example 7

As for example 4, with the exception that the polyester film was replaced by a foamed sheet of polyethylene sebacate of a density of 80 kg/m³ and a thickness of 300 μm.

### Example 8

As for example 4, with the exception that the film was applied to both sides. The resultant tray was utilised for packaging trials o beef. The results related to the mechanical properties and to the preservation of the meat were comparable to the ones observed for trays made with expanded polystyrene.

### Example 9

The tubular sheet obtained according to process of example 1 was formed directly in the conditions of example 3 with a male/female mould in the form of a tray 2.5 cm deep and 15×12 cm, to form a double container with a thickness of about 3 mm. The double container was positioned between two films of the type described in example 4, of 10 μm which were welded together forming a bag within which the tray was contained. The film was heat shrunk to form a compact and impermeable product for meat.

### Example 10

A mixture was prepared having the following composition:
74.3% by weight of potato starch (H₂O 16%)
10.0% by weight of Ecoflex EBX 7000 (BASF)
0.3% by weight of Loxiol G 10 F
15.4 by weight of water.

The composition was supplied to a twin screw extruder APV 2030 with (d)=30.0 mm and L/D=40. The operating conditions were as follows:

| | |
|---|---|
| RPM: | 170 |
| Temperature profile (° C.): | 30/100/100/150/160/150/140/130/110 × 8 |

The degassing step was adjusted so as to have in the pellets a water content of about 13.5-14.5%.

The pellets were then mixed with 2.5% of talc, with particles having mean diameter of 1.5 μm, and subsequently fed to a slow twin screw extruder with co-rotating screws having a diameter (d)=113.8 mm and L/D ratio=19:1. At the end of the extruder was mounted an extrusion head for a tubular sheet with a diameter of 100 mm and lip opening of 0.1 mm. The operating conditions were as follows:

| | |
|---|---|
| RPM: | 14 |
| Temperature profile (° C.): | 90/120/140/180/210/210/210/195/196 |
| Feed rate: | 75 kg/h |
| shear rate: | 31531 sec⁻¹ |

A further 0.8% by weight, with reference to the fed composition, of CO₂ was also added to the molten mass as a further expansion agent, at a feed pressure equal to 40 bar. The obtained foamed sheet had a thickness of about 5 mm, a density of 81 kg/m³ (calendered) and a average value of the cell dimension of 86 μm (cell dimension lying between 35 and 188 μm).

What is claimed is:

1. A foamed partly-finished product, comprising destructured or complexed starch foamed as a continuous phase, having a density of from 20 to 150 kg/m³, cell size of from 25 to 700 μm and a cell distribution such that 80% of the cells have, in the absence of stretching, a size ranging from 20 to 400 μm, said destructured or complexed starch is a natural starch derived from one member selected from the group consisting of potato, wheat, and tapioca starch, wherein the starch of the foamed product has an intrinsic viscosity in DMSO at 30° C. of from 0.3 to 1.5 dl/g and the foamed partly-finished product has a closed cell morphology in which the cells are substantially non-communicating with one another.

2. A foamed partly-finished product according to claim 1, having a density of from 25 to 100 kg/m³, cell size of from 40 to 600 μm and a cell distribution such that 80% of the cells have, in the absence of stretching, a size ranging from 25 to 300 μm.

3. A foamed partly-finished product according to claim 2, having a density of from 30 to 70 kg/m³ and a cell distribution such that 80% of the cells have, in the absence of stretching, a size ranging from 30 to 200 μm.

4. A foamed partly-finished product according to claim 3, having a density of from 30 to 70 kg/m³ and average cell size ranging from 80 to 120 μm.

5. A foamed partly-finished product according to claim 1, wherein the modified starch is selected from the group consisting of physically or chemically modified starches, ethoxylated starches, acetate starches, butyrate starches, propionate starches, hydroxypropylated starches, cationic starches, oxidated starches, cross-linked starches, gelatinised starches, starches complexed with molecules and/or polymers able to give “V” type complexes, dextrinated starches and starches grafted with chains selected from polyesters, polyurethanes, polyester-urethanes, polyureas, polyester-ureas, polysiloxanes, silanes, titanates, and fat chains.

6. A foamed partly-finished product according claim 1, in the form of products with hinges obtained in a forming phase capable of resisting at least ten consecutive opening/closing cycles at 35% RH and 23° C. without breaking, by using 2-4 seconds for each opening and closing operation.

7. A foamed partly-finished product according to claim 1, wherein the intrinsic viscosity in DMSO at 30° C. is from 0.4 to 1.2 dl/g.

8. A foamed partly-finished product according to claim 7, wherein the intrinsic viscosity in DMSO at 30° C. is from 0.6 to 1.1 dl/g.

9. A foamed partly-finished product according to claim 1, containing one or more thermoplastic polymers with a melting point of from 60 to 175° C.

10. A foamed partly-finished product according to claim 9, wherein the thermoplastic polymer is selected from the group consisting of a polymer of natural origin which can be modified or non modified, a polymer derived from cellulose as cellulose acetate, cellulose propionate, cellulose butyrate and their co-polymers, with a degree of substitution lying between 1 and 2.5; polymers of the alkyl cellulose, hydroxy alkyl cellulose, carboxy alkyl cellulose type, carboxy methyl cellulose, nitrocellulose and chitosan pullulan or casein and casinate, zein, soya protein, alginic acid and alginates, natural rubbers, polyaspartates; glutens, and dextrens.

11. A foamed partly-finished product according to claim 9, wherein the thermoplastic polymer is selected from the group consisting of biodegradable polymers of synthetic or fermentative origin, polyesters of the type including polymers or co-polymers of C₂-C₂₄ aliphatic hydroxy acids, or their corresponding lactones or lactides, polymers of lactic acid having various D/L lactic acid ratios, co-polymers of polylactic acid with aliphatic and aliphatic-aromatic polyesters, polycaprolactone, polyvalerolactone, their co-polymers and also polyesters derived from difunctional acids and aliphatic diols, aliphatic-aromatic polyesters, co-polymers of the type including alkaline-terephthalate adipate treated or not with chain extenders, optionally with quantities of terephtalic acid less than forty mole percent, epoxy resin and bisphenolic resin.

12. A foamed partly-finished product according to claim 9, wherein the thermoplastic polymer is a polymer containing hydrophilic groups intercalated in hydrophobic sequences selected from the group consisting of ethylene-vinylalcohol co-polymers, ethylene vinylacetate co-polymers, acrylic esters, acrylic ethylene-ester co-polymers, co-polymers of ethylene with unsaturated acids selected from the group consisting of acrylic acid, methacrylic acid, crotonic acid, itaconic acid, co-polymers with hydrophilic units with a functional alcoholic a carboxylic group in aliphatic polyesters and/or aromatic-aliphatic polyesters, and epoxy resins including resins containing bisphenols.

13. A foamed partly-finished product according to claim 9, wherein the thermoplastic polymer is a polymer able to form hydrogen bonds with the starch selected from the group consisting of polyvinyl alcohol with various degrees of hydrolysis, optionally modified with acrylates or methacrylates, and polyvinyl alcohol preliminarily plastisized or modified for the purpose of lowering its melting point.

14. A foamed partly-finished product according to claim 9, containing polymers selected from the group consisting of polyvinylalcohol, copolymers of an olefin polymer, ethylene, with a monomer chosen from vinyl alcohol, vinyl acetate, acrylic acid and methacrylic acid, aliphatic polyesters, caprolactone, the polyalkylene succinates, the polymers of azelaic acid, sebacic acid, brassilic acid and their co-polymers, aliphatic polyamides, polyalkylenesebacates, polyalkylene-azelates, polyalkylenebrassilates, with diols comprised between C₂-C₁₃, polyesters containing dimeric acids, aromatic-aliphatic polymers of the polyalkylene terepthalate adipate type and the epoxy resins, with bisphenolic groups.

15. A foamed partly-finished products according to claim 1, containing nucleating agents for the starting composition in concentrations of from 0.05 to 10% by weight.

16. A foamed partly-finished product according to claim 15, wherein the nucleating agent is constituted by inorganic compositions selected from the group consisting of talc (magnesium silicate), calcium carbonate, sulphates of sodium and barium, titanium dioxide, optionally surface treated with adhesion promoters.

17. A foamed partly-finished product according to claim 1, containing organic fillers and fibres selected from the group consisting of wood powder, cellulose, grape residue powder, bran, maize husks and other natural fibres in concentrations of from 0.5 to 20%.

18. A foamed partly-finished product according to claim 1, containing nucleating agents, lubricants and/or dispersants and plasticisers.

19. A foamed partly-finished product according to claim 1 containing alimentary oils selected from group consisting of palm oil, maize oil, soya oil, sunflower oil, C₁₂ to C₂₂ fatty acids, their glycerides with various degrees of substitution, and hydrogenated fats of animal or synthetic origin which are solid at least at ambient temperatures, or above ambient temperatures, to improve the moisture resistance and reduce the wettability by water.

20. A foamed partly-finished product according to claim 1 containing weak acids selected from the group consisting of lactic acid, tartaric acid, and citric acid to regulate the viscosity of the starch during the extrusion process.

21. Products and partly-finished products obtained from the foamed partly-finished products of claim 1, obtained by lamination with layers of non-woven fabric, woven fabric, paper, biodegradable and non-biodegradable films or aluminium.

22. Products and partly-finished products according to claim 21 produced by lamination with non-woven fabric or woven fabric of natural fibres, fibre based on polysaccharides or fibres produced starting from biodegradable polymers.

23. Products and partly-finished products according to claim 21 coupled with films constituted by biodegradable polymers.

24. Products and partly-finished products obtained from the foamed partly-finished products of claim 1, by way of coating with emulsions, dispersions, solutions, hot melts of biodegradable polymers.

25. Products and partly-finished products according to claim 23, in which the films are coupled to the partly-finished products by temperature and/or the application of suitable biodegradable adhesives based on polymers of lactic acid, polyurethanes, polyvinylacetates and polyvinylalcohols, proteins, starches, dextrins and other polysaccharides.

26. Products and partly-finished products according to claim 23, wherein the films can be obtained from cast and bubble film-forming and can be co-extruded with an adhesive surface for the foamed support.

27. Products and partly-finished products according to claim 26, wherein the films have a melting point greater than 60° C.

28. A sheet according to claim 23 formable as a non-laminated sheet.

29. Products and partly-finished products obtained from the materials of claim 1, treated with natural and synthetic waxes with melting points up to 120° C.

30. Combinations of partly finished product according to claim 1 in multilayer structures to form products of various geometry.

31. Combinations of materials according to claim 1, with other supports to provide multilayers mixed with wood, paper, cardboard, non-woven fabric, woven fabric of natural or synthetic fibres, aluminium or other metals.

32. A foamed partly-finished product, comprising destructured or complexed starch foamed as a continuous phase, having a density of from 20 to 150 kg/m³, cell size of from 25 to 700 μm and a cell distribution such that 80% of the cells have, in the absence of stretching, a size ranging from 20 to 400 μm, said destructured or complexed starch is a natural starch derived from maize, wherein the starch of the foamed product has an intrinsic viscosity in DMSO at 30° C. of from 0.3 to 1.5 dl/g and the foamed partly-finished product has a closed cell morphology in which the cells are substantially non-communicating with one another.

33. A formed partly-finished product according to claim 1, wherein said destructured or complexed starch is tapioca starch.

34. A formed partly-finished product according to claim 1, wherein said destructured or complexed starch is wheat starch.

35. A formed partly-finished product according to claim 1, wherein said destructured or complexed starch is potato starch.

36. A formed partly-finished product according to claim 32, wherein said destructured or complexed starch has an amylose content of 28 wt % or less.

37. A foamed partly-finished product adapted to be further processed into a finished article of manufacture comprising destructured or complexed starch foamed as a continuous phase and a thermoplastic polymer, said article having a density lying between 20 and 150 kg/m³, cell dimension in a range between 25 and 700 μm with a cell distribution such that 80% of them have, in the absence of stretching, a dimension lying between 25 and 400 μm, wherein the material from which the foam is made has an intrinsic viscosity in DMSO at 30° lying between 1.5 and 0.3 dl/g and said thermoplastic polymer comprises polyesters derived from di-functional acids and aliphatic diols or aliphatic-aromatic polyesters.
